(19) United States
(12) Patent Application Publication
(10) Pub. No.: US 2019/0024614 A1
(43) Pub. Date: Jan. 24, 2019

(54) CARBURETOR WITH MAINTENANCE PORT

(71) Applicant: TTI (MACAO COMMERCIAL OFFSHORE) LIMITED, Macau (MO)

(72) Inventor: Eric Nolin, Anderson, SC (US)

(21) Appl. No.: 16/068,863

(22) PCT Filed: Jan. 9, 2017
(86) PCT No.: PCT/US17/12711

§ 371 Date: Jul. 9, 2018

Related U.S. Application Data
(60) Provisional application No. 62/276,381, filed on Jan. 8, 2016.

(51) Int. Cl. F02M 17/36; F02M 7/26; F02M 7/18

(52) U.S. Cl. CPC F02M 17/36; F02M 7/18; F02M 7/26

(57) ABSTRACT

A carburetor, a method of assembling a carburetor, and a method of operating an engine. The carburetor may generally include a housing defining a pump portion and a metering portion; and a maintenance port in communication with the pump portion and the metering portion to allow direct introduction of an additive through the maintenance port and into the pump portion and the metering portion.

### CROSS-REFERENCE TO RELATED APPLICATION

This application claims priority to co-pending, prior-filed U.S. Provisional Patent Application No. 62/276,381, filed Jan. 8, 2016, the entire contents of which are incorporated by reference.

### FIELD

The invention relates to carburetors and, more particularly, to carburetors used for small engines.

### SUMMARY

Small engines often use a carburetor to provide a fuel-air mixture to the engine for combustion. These small engines are often used to power equipment that is used seasonally (e.g., lawn mowers, snow throwers, blowers, trimmers, etc.). These seasonal engines often sit for long periods of time without operating. These engines can be difficult to start after these long dormant periods.

In one independent embodiment, a carburetor may generally include a housing defining a pump portion and a metering portion; and a maintenance port in communication with both the pump portion and the metering portion to allow direct injection of an additive through the maintenance port, the pump portion, and the metering portion.

In another independent embodiment, a method of assembly a carburetor may be provided. The carburetor may include a housing defining a pump portion and a metering portion. The method may generally include providing a maintenance port in communication with at least one of the pump portion and the metering portion to allow direct introduction through the maintenance port and into the at least one of the pump portion and the metering portion.

In yet another independent embodiment, a carburetor may generally include a housing defining a pump portion, a first channel in communication with the pump portion, a metering portion, and a second channel in communication with the metering portion; and a maintenance port in communication with the pump portion through the first channel to allow direct introduction through the maintenance port and into the pump portion and in communication with the metering portion through the second channel to allow direct introduction through the maintenance port and into the metering portion.

In a further independent embodiment, a method of operating an engine may be provided. The engine may include a carburetor, and the carburetor may include a housing defining a pump portion and a metering portion, and a maintenance port in communication with at least one of the pump portion and the metering portion. The method may generally include directly introducing an additive through the maintenance port and into the at least one of the pump portion and the metering portion; and starting the engine.

Other independent aspects of the invention will become apparent by consideration of the detailed description, claims and accompanying drawings.

### BRIEF DESCRIPTION OF THE DRAWINGS

FIG. 1 is a perspective view of a carburetor.

FIG. 2 is a schematic illustration of the carburetor FIG. 1.

FIG. 3 is a cross-sectional view of the carburetor of FIG. 1, taken generally along line 3-3.

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

The use of “including”, “comprising”, or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

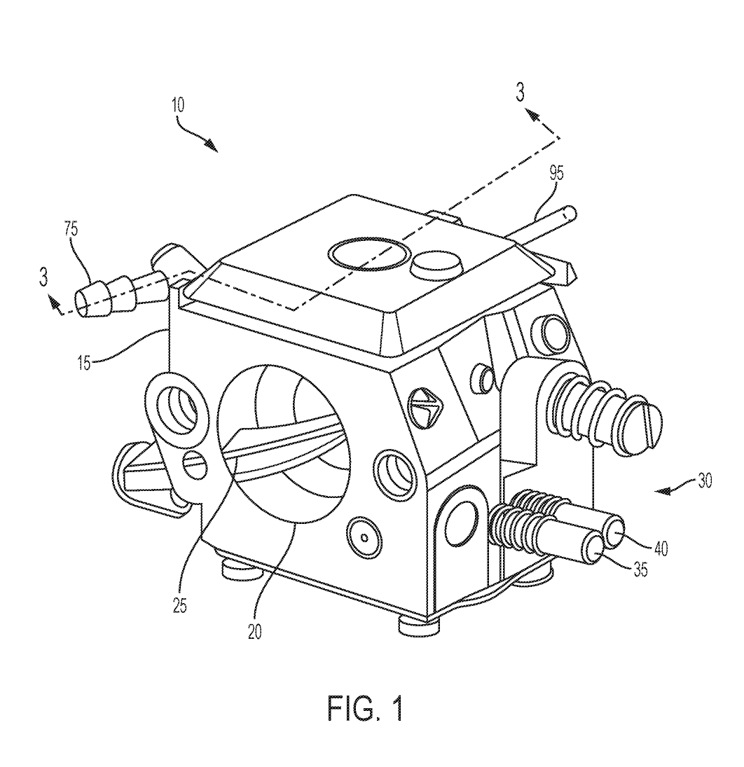

Referring to FIG. 1, a carburetor 10 for use with a small engine (not shown) includes a carburetor body 15, defining an air passage 20, and a throttle valve 25 movable to control the size of the air passage 20. The carburetor 10 also includes one or more adjustment members 30 allow the user to adjust the fuel flow within the carburetor 10. For example, the carburetor 10 may include an idle control 35 that can be adjusted to control the amount of fuel flow to the carburetor 10 when the engine is idling and a second full-speed control 40 that controls the quantity of fuel that flows into the carburetor 10 at full speed.

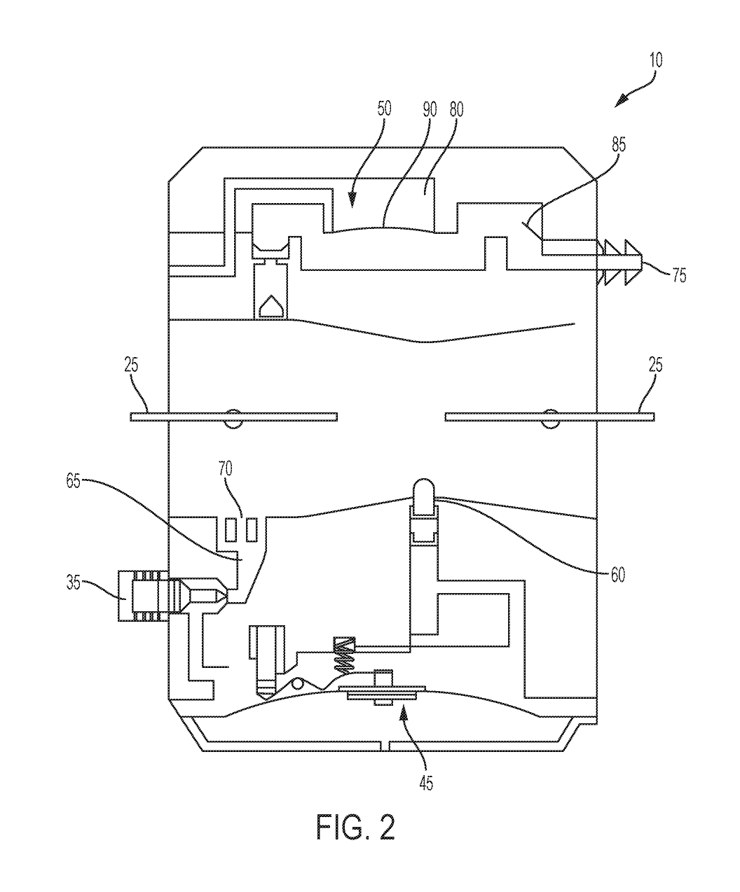

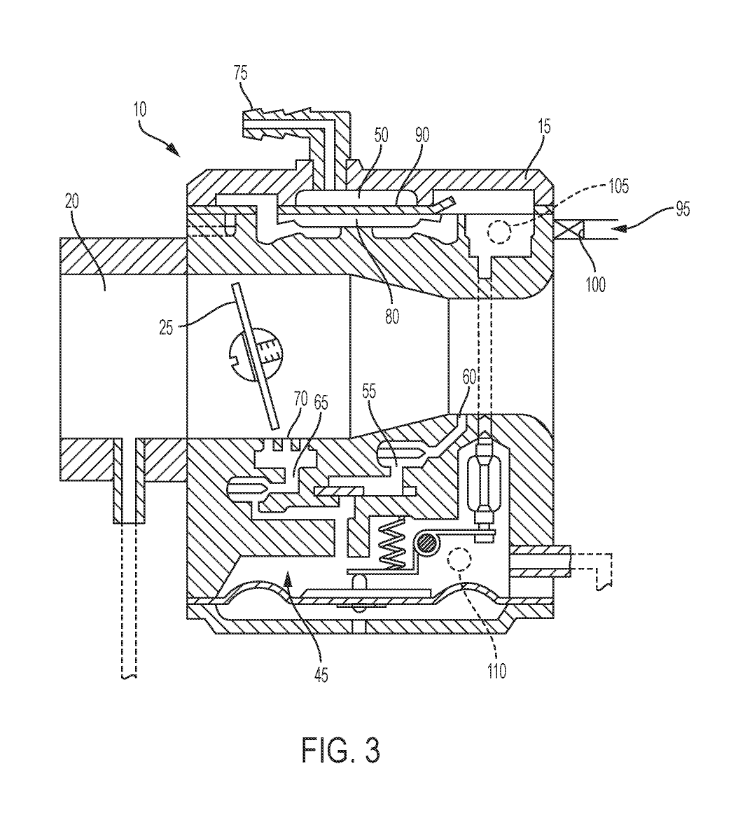

With reference to FIGS. 2-3, the flow paths within the carburetor 10 include a metering portion 45 and a pump portion 50 within the carburetor body 15. The metering portion 45 is arranged to control the flow of fuel into the air passage 20 during engine operation. In the illustrated construction, a first flow path 55 directs fuel to a main nozzle 60 which feeds the engine during normal engine operation and a second flow path 65 directs fuel to the idle ports 70 and then to the air passage 20 during idle operation.

The pump portion 50 includes a fuel inlet 75 that provides a supply of fuel to a pump chamber 80. As shown in FIG. 2, a check valve 85 is positioned between the pump chamber 80 and the air passage 20 to inhibit unwanted flow of fuel into the air passage 20. A pump mechanism 90, for example, a flexible bulb, is used to reduce the space within the pump chamber 80 to force fuel into the air passage 20.

To operate the carburetor 10, the user first pumps the pump mechanism 90 to force fuel into the air passage 20. The engine is then started. As air flows through the carburetor 10 during the starting process, the fuel from the pump portion 50 mixes with the air to produce a fuel-rich mixture that improves the starting capability of the engine. Once the engine starts, fuel is added to the air passage 20 via the main nozzle 60 and the idle ports 65 of the metering portion 45. The throttle valve 25 is operated by the user to control the air flow through the carburetor 10 which, in turn, controls the power output of the engine.

Seasonal small engines which typically use carburetors of this type often remain idle for long periods of time. During this time, the carburetor can become corroded or coated with thickened hydrocarbons that are difficult to remove. Additives are available that reduce the corrosion and remove the hydrocarbons from the carburetor. However, these additives are typically added to the fuel and clean the carburetor as fuel flows through the carburetor. To do so, these additives generally require a running engine.

With reference to FIG. 3, the illustrated carburetor 10 includes a maintenance port 95 into which fluid or other material, such as a carburetor cleaning or fuel treatment system additive, can be added. The maintenance port 95 provides an inlet to a flow path connected to both the pump portion 50 and the metering portion 45 of the carburetor 10.

In the illustrated embodiment, a check valve 100 is provided to inhibit unwanted entry or exit of fluids through the maintenance port 95. A first channel 105 extends from the maintenance port 95 to the pump portion 50 to provide a flow path for the delivery of additive to the pump portion 50. A second channel 110 extends from the maintenance port 105 to the metering portion 45 of the carburetor 10 to provide for the delivery of the additive to this portion of the carburetor 10.

In use, the user injects additive into the carburetor 10 via the maintenance port 95 without the engine operating. The check valve 100 opens to allow the fluid to flow to the pump portion 50 of the carburetor 10. If there is sufficient pressure, the check valve 85 in the pump portion 50 may open to allow some of the additive to flow into the air passage 20. If there is not sufficient pressure, a user may operate the pump member 90 to force some of the fluid into the air passage 20. In addition, additive flows through the second channel 110 and into the metering portion 45 of the carburetor 10. In the metering portion 45, the additive is free to flow through the main nozzle 60 and the idle ports 70 into the air flow path, thereby assuring that all of the openings, flow paths, and ports within the carburetor 10 receive some of the additive and are cleaned.

One or more independent features and/or independent advantages of the invention may be set forth in the following claims:

1. A carburetor comprising:
a housing defining a pump portion and a metering portion; and
a maintenance port in communication with at least one of the pump portion and the metering portion to allow direct introduction through the maintenance port and into the at least one of the pump portion and the metering portion.

2. The carburetor of claim 1, wherein the maintenance port is in communication with both of the pump portion and the metering portion to allow direct introduction through the maintenance port into at least one of the pump portion and the metering portion.

3. (canceled)

4. The carburetor of claim 1, further comprising a check valve downstream of the maintenance port.

5. The carburetor of claim 4, further comprising a user-manipulable pump mechanism operable to increase pressure within the pump portion to force additive beyond the check valve.

6. The carburetor of claim 1, further comprising a first channel extending from the maintenance port to the pump portion to provide a flow path to the pump portion, and a second channel extending from the maintenance port to the metering portion to provide another flow path to the metering portion.

7-8. (canceled)

9. The carburetor of claim 1, wherein the housing defines an air passage, and wherein the carburetor further comprises a throttle valve movable to control the size of the air passage.

10. The carburetor of claim 9, further comprising a first control operable to be adjusted to control the amount of fuel flow to the air passage when the engine is idling, and a second control operable to be adjusted to control the amount of fuel flow to the air passage when the engine is at full speed.

11-24. (canceled)

25. A carburetor comprising:
a housing defining a pump portion, a first channel in communication with the pump portion, a metering portion, and a second channel in communication with the metering portion; and
a maintenance port in communication with the pump portion through the first channel to allow direct introduction through the maintenance port and into the pump portion and in communication with the metering portion through the second channel to allow direct introduction through the maintenance port and into the metering portion.

26. The carburetor of claim 25, further comprising a check valve downstream of the maintenance port.

27. The carburetor of claim 26, further comprising a user-manipulable pump mechanism operable to increase pressure within the pump portion to force additive beyond the check valve.

28. The carburetor of claim 25, wherein the housing defines an air passage, and wherein the carburetor further comprises a throttle valve movable to control the size of the air passage.

29. The carburetor of claim 28, further comprising a first control operable to be adjusted to control the amount of fuel flow to the air passage when the engine is idling, and a second control operable to be adjusted to control the amount of fuel flow to the air passage when the engine is at full speed.

30-31. (canceled)

32. A method of operating an engine, the engine including a carburetor, the carburetor including a housing defining a pump portion and a metering portion, and a maintenance port in communication with at least one of the pump portion and the metering portion, the method comprising:
directly introducing an additive through the maintenance port and into the at least one of the pump portion and the metering portion; and
starting the engine.

33. The method of claim 32, wherein directly introducing includes directly introducing additive through the maintenance port into at least one of the pump portion and the metering portion, wherein the maintenance port is in communication with both of the pump portion and the metering portion.

34. (canceled)

35. The method of claim 32, further comprising operating a user-manipulable pump mechanism to increase pressure within the pump portion, thereby forcing additive beyond a check valve that is downstream of the maintenance port.

36. The method of claim 32, wherein directly introducing includes directly introducing an additive through the maintenance port and a first channel and into the pump portion, wherein the first channel extends from the maintenance port to the pump portion to provide a first flow path to the pump portion.

37. (canceled)

38. The method of claim 36, wherein directly introducing includes directly introducing an additive through the maintenance port and a second channel and into the metering portion, wherein the second channel extends from the maintenance port to the metering portion to provide a second flow path to the metering portion.

39. The method of claim 32, further comprising adjusting a throttle valve that is movable to control the size of an air passage, wherein the air passage is defined within the housing.

40. The method of claim 39, further comprising adjusting a first control when the engine is idling, wherein the first control is operable to be adjusted to control the amount of fuel flow to the air passage.

41. (canceled)

42. The method of claim 40, further comprising adjusting a second control when the engine is at full speed, wherein the second control is operable to be adjusted to control the amount of fuel flow to the air passage.
